(19) United States
(12) Patent Application Publication
(10) Pub. No.: US 2022/0032348 A1
(43) Pub. Date: Feb. 3, 2022

(54) MOVABLE DUST COLLECTION DEVICE

(71) Applicant: CHING-LONG LIN, Changhua County (TW)

(72) Inventor: CHING-LONG LIN, Changhua County (TW)

(21) Appl. No.: 17/203,712

(22) Filed: Mar. 16, 2021

(30) Foreign Application Priority Data
Jul. 29, 2020 (TW) 109125543

(51) Int. Cl. B08B 15/04; B23D 19/00; B23D 33/00

(52) U.S. Cl. CPC B08B 15/04; B23D 33/00; B23D 19/00

(57) ABSTRACT

A movable dust collection device includes a processing table, a processing machine, and a collection unit. By the movable suction box, the dust, small parts and debris under the processing gun can be directly sucked and collected. The control unit controls the motor to drive the driving wheels to move the suction box beyond the processing table, which facilitates the cleaning of the small parts and debris, and improves the shortcoming of lifting the entire collection board for cleaning in the prior art.

### BACKGROUND OF THE INVENTION

### 1. Fields of the Invention

The present invention relates to a dust collection device used in metal cutting processing, and more particularly, to a movable induction synchronous dust collection device.

### 2. Descriptions of Related Art

The conventional dust collector known to applicant is disclosed in Taiwanese Publication Number 1354590 which is entitled as “Direct Suction Type Negative Pressure Metal Cutting Dust Collector”. The above mentioned dust collector includes a joint part which is connected to an air door on an air duct to form a seesaw state. When a slide door moves to the joint part, one end of the joint part is pressed by the slide door that moves with the processing machine so as to swing upward by pulling the air door. Therefore, the smoke in the wind box can be sucked into the air duct, and then the smoke is sucked out by a blower.

The collection board and the base board are able to be separated, so that when cleaning the debris, the collection board is lifted so as to clean up the debris on the baes board. It requires a large lift device to lift the collection board, and that is difficult to operate, and also labor-intensive.

The present invention intends to provide a movable induction synchronous dust collection device to eliminate shortcomings mentioned above.

### SUMMARY OF THE INVENTION

The present invention relates to a dust collection device and comprises a processing table including two side walls, and a plurality of transverse plates connected between the two side walls. The two side walls are installed on an installation floor. An air duct is provided in the processing table and located close to one of the side walls. A blower is connected to one end of the air duct. A processing machine includes a processing gun, and two foot bases cross outside of the processing table. The processing machine is movable along the length direction of the processing table with the two foot bases. A collection unit is located in the processing table and includes a suction box 41, a drive unit 42, and a control unit 43. The suction box communicates with the air duct and has two dust boxes and an air path. The air path is located between the two dust boxes. Each dust box includes a plurality of suction holes that are in communication with the air path. The driving unit includes a motor, and a plurality of driving wheels are arranged on the bottom of the suction box. The control unit includes a controller, a transmitter, and a plurality of receivers that are electrically connected to each other. The controller is electrically connected to the motor. The transmitter transmits wireless signals which are received by the receivers when the processing machine moves. The controller controls the motor to drive the driving unit to drive the suction box to move with the processing machine, so that suction airflow of the air duct passes through the dust boxes of the suction box and the air path to collect small parts and debris below the processing gun. The control unit controls the motor to drive the driving wheel to support the suction box to move out from the processing table to clean the small parts and the debris.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the dust collection device of the present invention;

FIG. 2 shows that the collection unit moves beyond the processing table;

FIG. 3 is a perspective view to show processing table of the dust collection device of the present invention;

FIG. 4 is a side view of the dust collection device of the present invention;

FIG. 5 is a bottom perspective view of the dust collection device of the present invention;

FIG. 6 is a cross sectional view, taken along line VI-VI in FIG. 1;

FIG. 7 is a cross sectional view, taken along line VII-VII in FIG. 4;

FIG. 8 shows that the control unit is controlled by wireless signal to drive the suction box to move with the process machine;

FIG. 9 shows that the container is provided on the installation floor, a collection bucket is located in the container, and an opening is provided at the bottom of the air path;

FIG. 10 shows that the debris is collected in the collection bucket in the container;

FIG. 11 shows another embodiment of the suction box of the present invention, and

FIG. 12 is a cross sectional view, taken along line XII-XII in FIG. 11.

### DETAILED DESCRIPTION OF THE PREFERRED EMBODIMENT

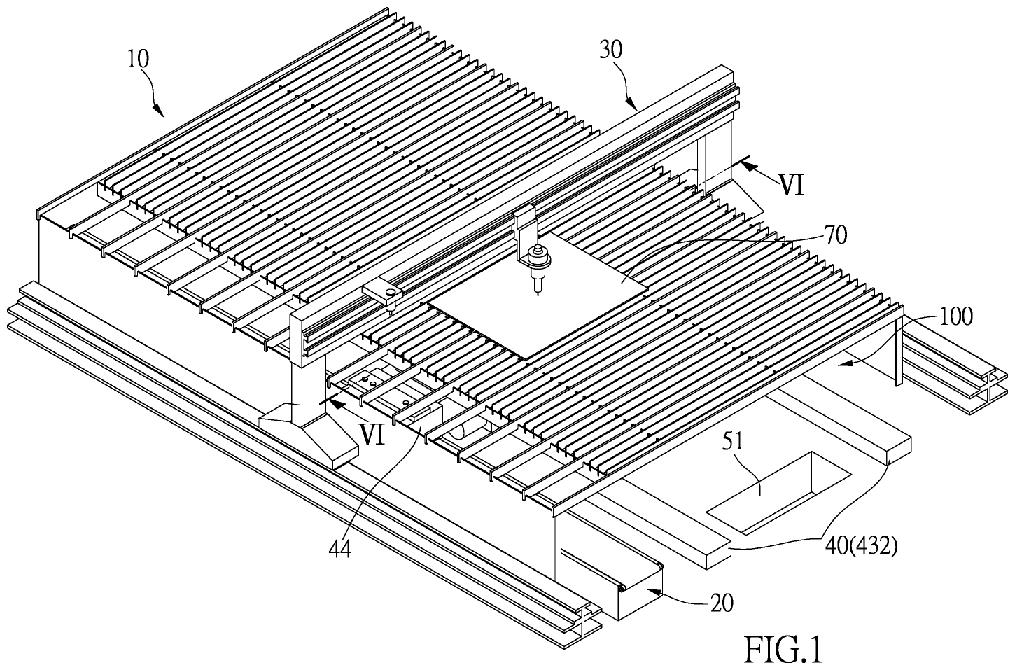

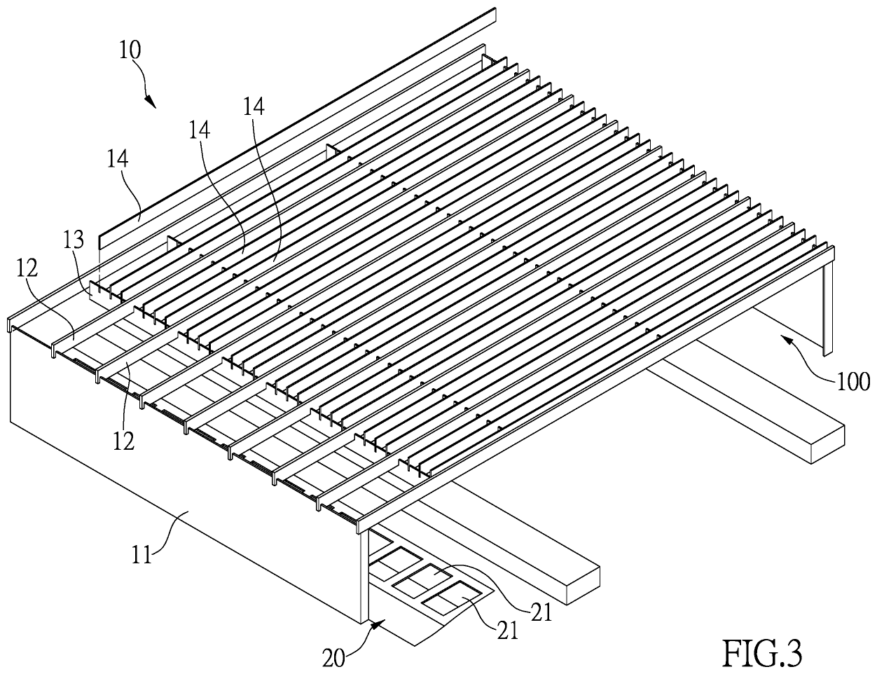

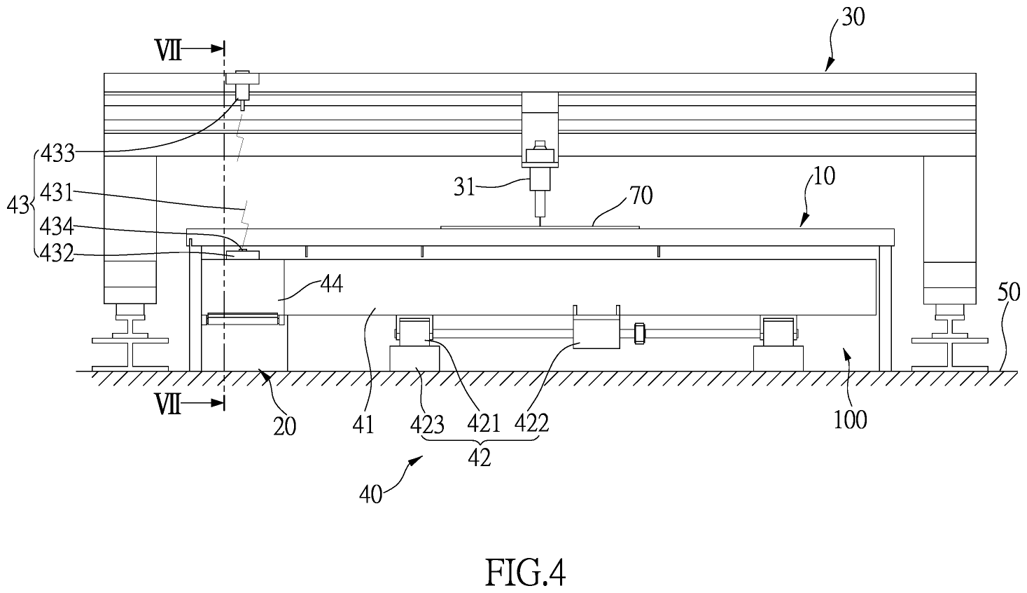

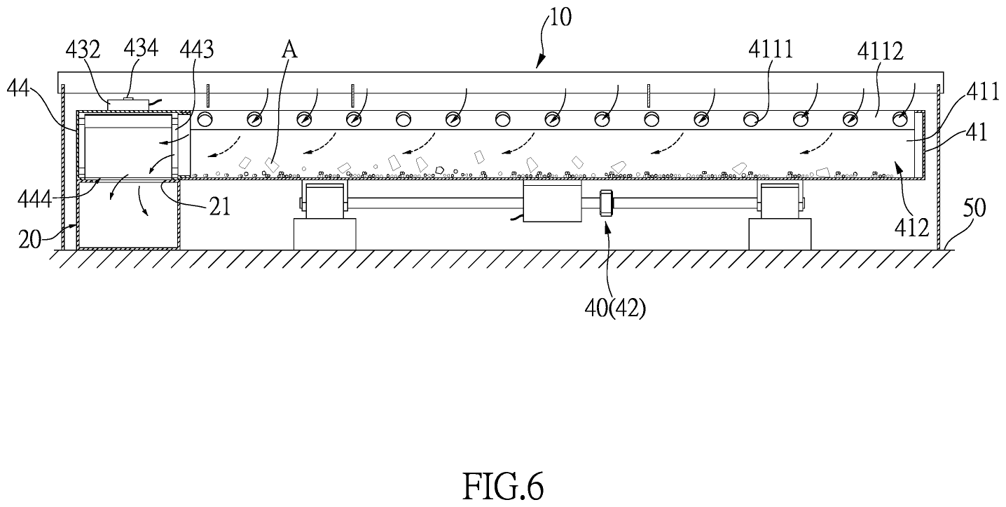

Referring to FIGS. 1 to 10, the movable induction dust collection device of the present invention comprises a processing table 10 which includes two side walls 11, a plurality of transverse plates 12 connected between the two side walls 11, and a dust collecting space 100 that is located between the two side walls 11 and the transverse plates 12. The two side walls 11 are installed on an installation floor 50.

An air duct 20 is provided in the long structure of the processing table 10 and is located close to one of the side walls 11. A blower 60 is connected to one end of the air duct 20.

A processing machine 30 includes a processing gun 31 extending downward from one side of the processing machine 30, and two foot bases 32 that across the outside of the processing table 10. The processing machine 30 moves along the length direction of the processing table 10 with the two foot bases 32.

A collection unit 40 is located in the processing table 10, and includes a suction box 41, a drive unit 42, and a control unit 43. The suction box 41 communicates with the air duct 20 and has two dust boxes 411 and an air path 412. The air path 412 is located between the two dust boxes 411, and each dust box 411 includes a plurality of suction holes 4111 that are in communication with the air path 412. The driving unit 42 includes a plurality of driving wheels 421 arranged on the bottom of the suction box 41, and a motor 422. The control unit 43 includes a controller 432, a transmitter 433, and a plurality of receivers 434 that are electrically connected to each other. The controller 432 is electrically connected to the motor 422. The transmitter 433 continuously transmits wireless signals 431 which are received by the receivers 434 when the processing machine 30 moves. The controller 432 controls the motor 422 to drive the driving unit 42 to operate and drives the suction box 41 to move with the processing machine 30, so that the suction airflow of the air duct 20 passes through the dust boxes 411 of the movable suction box 41 and the air path 412 to form a centralization and dust collection effect below the processing gun 31. In the same time, small parts and debris “A” are collected. The control unit 43 controls the motor 422 to drive the driving wheel 421 to support the suction box 41 to move out from the processing table 10 to clean the small parts and the debris “A”.

The suction airflow of the air duct 20 passes through the air path 412 of the suction box 41, and is movable to suck and collect dust directly from the bottom of the processing gun 31. The movable suction box 41 can be operated to make the suction air flow be centralized so as to amplify the collection effect to the dust and smoke. That is to say, the desired suction effect is achieved with smaller suction horsepower. The present invention effectively reduces consumption of electric power, and achieves energy saving and carbon reduction.

In addition, the mobility of the air path 412 collects the small parts and debris “A” below the processing gun 31. The control unit 43 controls the motor 422 to drive the driving wheel 421 to support the suction box 41 to move out from the processing table 10 so that the small parts and the debris “A” can easily be collected by a hand tool.

In addition, the size of the suction box 41 and the air path 412 can be changed to meet the requirements of the horsepower and energy consumption factors of the motor 422.

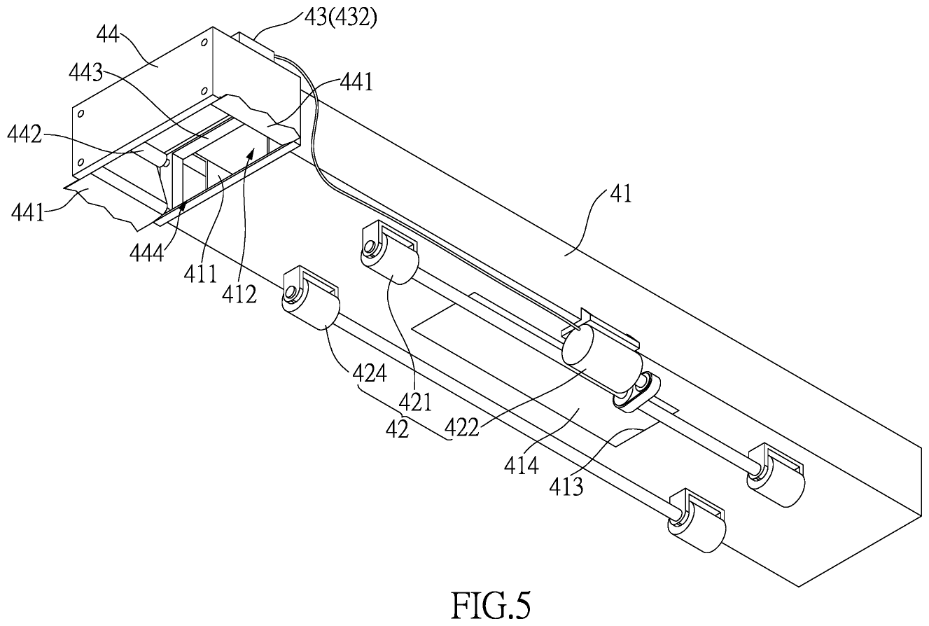

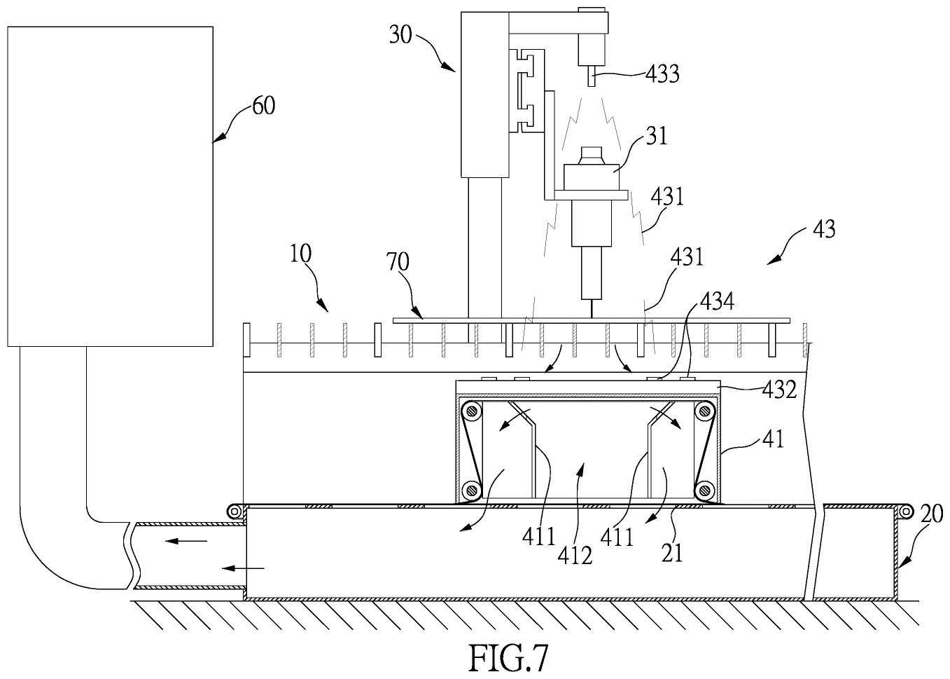

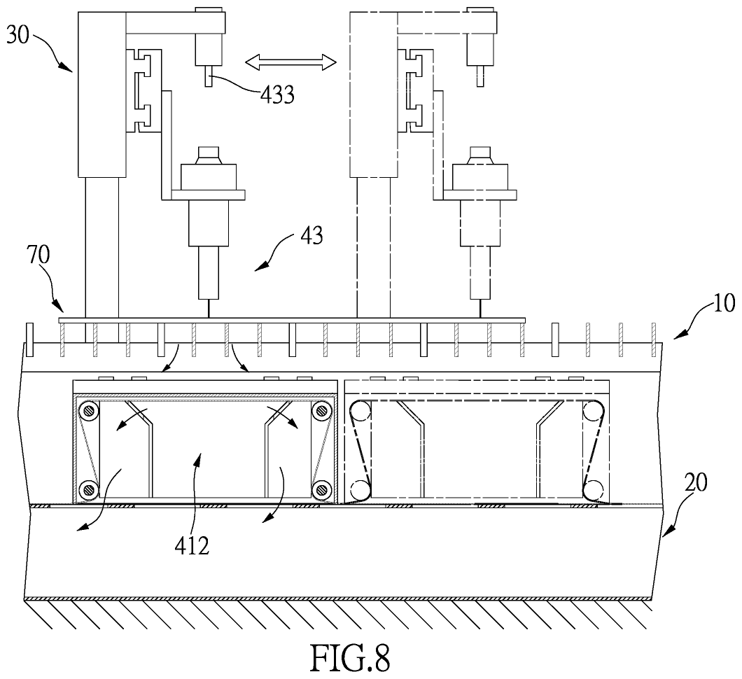

As shown in FIGS. 1 to 9, the two dust boxes 411 each have two inclined surfaces 4112 extending downwardly toward one side of the air path 412. The suction holes 4111 are located on the two inclined surfaces 4112 and communicate the two dust boxes 411 and the air path 412. As shown in FIGS. 5 to 8, the air duct 20 has a plurality of holes 21 spaced apart on the top surface thereof. The collection unit 40 includes a turning box 44 that is connected with the air duct 20 and one end of the suction box 41. The turning box 44 includes a belt 441, a plurality of rollers 442, and a side suction port 443 and a lower suction port 444 respectively communicating with an interior of the turning box 44. The two ends of the belt 441 pass through two sides of the lower suction port 444, and are connected to the two ends of the top surface of the air duct 20 so as to close the holes 21 that are not located corresponding to the lower suction ports 444. The turning box 44 is guided by the rollers 442 to move along the belt 441 on the top surface of the air duct 20, and changes positions of the holes 21 that are located corresponding to the lower suction port 444. The side suction port 443 communicates with one end of the dust box 411 and the air path 412. As shown in FIGS. 7 and 8, the controller 432 of the control unit 43 is located above the turning box 44. There are four receivers 424 arranged in two groups (attached to the controller 432 as shown). The transmitters 422 are located to the processing machine 30 and above the receivers 434. When the wireless signal 431 between one of the two groups of the receivers 424 and the transmitter 422 is shielded by the transverse plates 12 of the processing table 10, the controller 432 receives the wireless signal 431 from another one of the two groups of the receivers 424. When the two groups of the receivers 424 are not shielded, the controller 432 takes the middle value of the wireless signals 431 received by the two groups of the receivers 424 to keep the wireless signal uninterrupted. As shown in FIGS. 1 to 3, the processing table 10 includes a plurality of first plates 13 and a plurality of second plates 14. The plurality of first plates 13 are arranged vertically connected to the bottom of transverse plates 12. The plurality of second plates 14 are arranged at intervals between any two transverse plates 12 and are connected to the upper side of the first plates 13. The transverse plates 12, the first plates 13 and the second plates 14 support a workpiece 70.

As shown in FIGS. 1 to 3, the driving unit 42 includes a plurality of rails 423 and a plurality of passive wheels 424. The rails 423 are provided on the installation floor 50 and are parallel to the moving direction of the processing machine 30. The plurality of passive wheels 424 are provided on the bottom of the suction box 41 and movable on the rails 423 with the driving wheels 421.

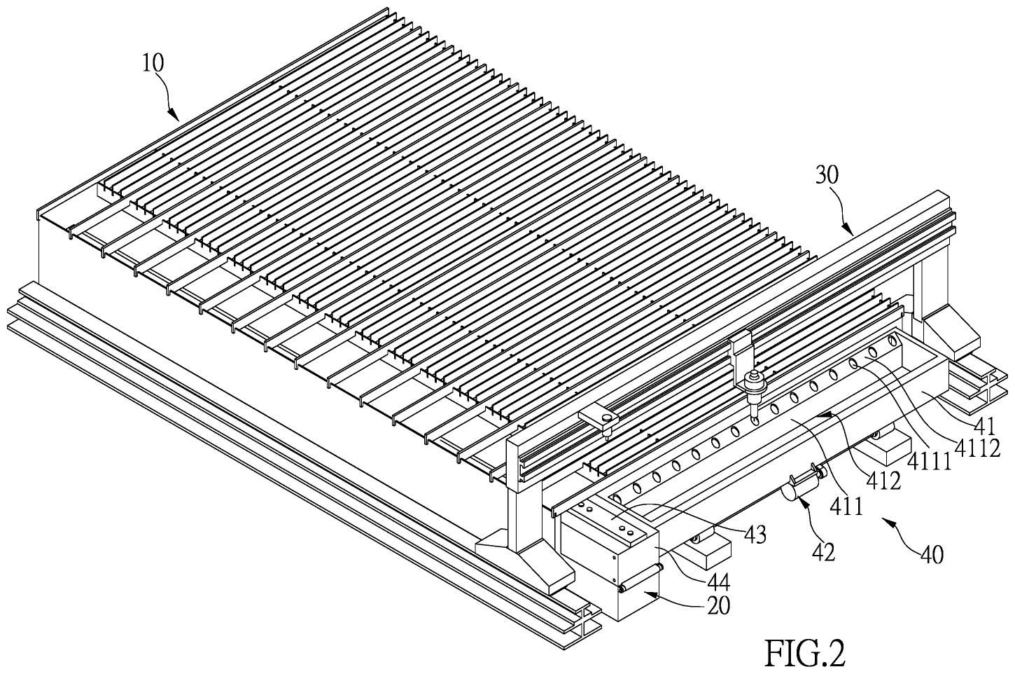

As shown in FIG. 2, one end of each rail 423 protrudes beyond the processing table 10, so that the controller 432 can control the motor 422 to drive the suction box 41 to move beyond the processing table 10 through the driving wheel 421. This facilitates the cleaning of the small parts and debris “A” in the air path 412. The small parts and debris “A” in the air path 412 can be shoveled out by a tool.

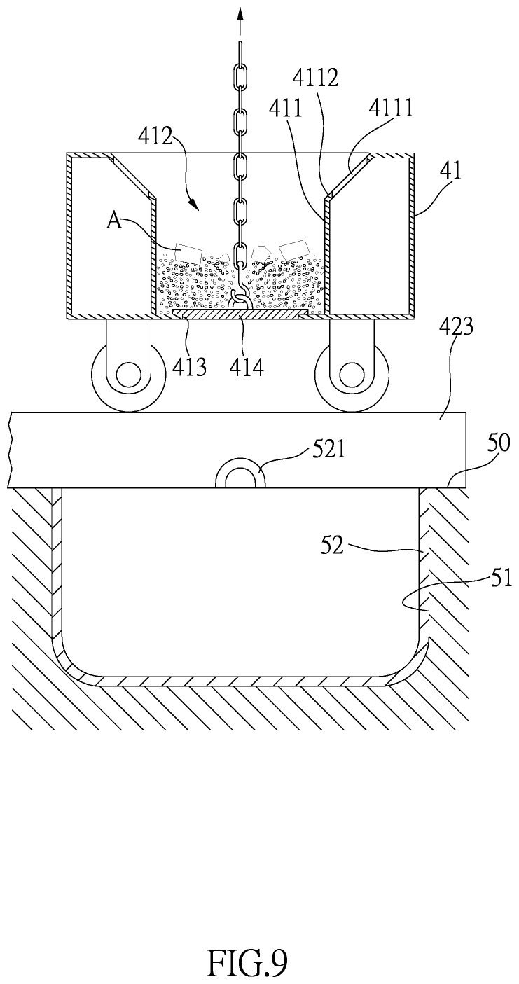

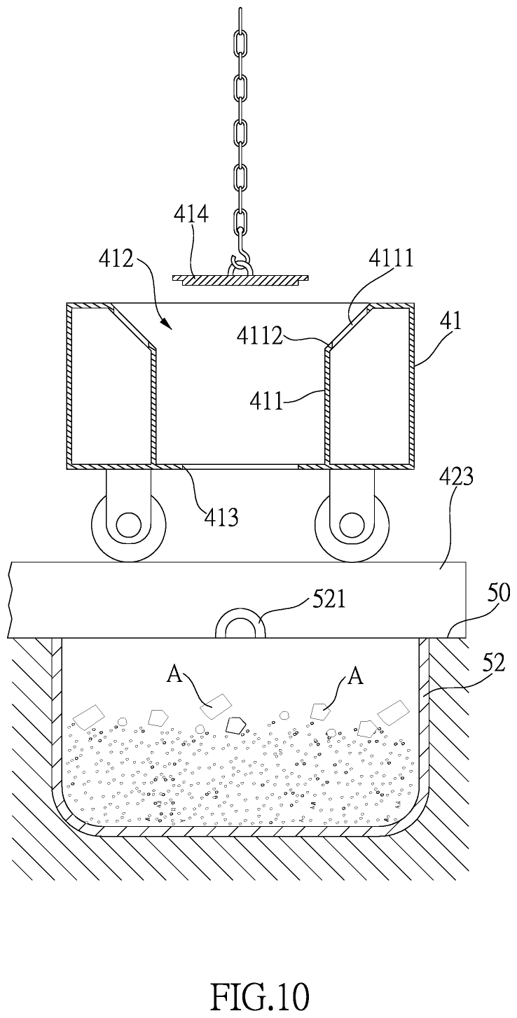

As shown in FIGS. 9 and 10, the suction box 41 includes an opening 413 provided at the bottom of the air path 412, and a cover 414 removably covers the opening 413. By removing the cover 414 from the opening 413, the debris “A” drops from the opening 413 and is collected. A container 51 is provided on the installation floor 50, and a collection bucket 52 is located in the container 51 so as to collect the debris “A”. The collection bucket 52 has a plurality of handles 521 connected thereto. The small parts and debris “A” are collected in the collection bucket 52, and the collection bucket 52 is lifted and moved by the handles 521 complete the cleaning. This improves the shortcoming of lifting the processing table 10 for cleaning of the aforementioned conventional way.

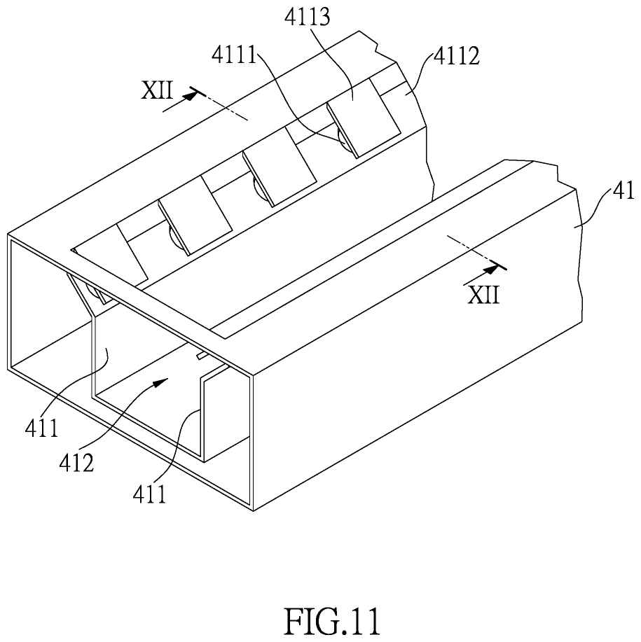

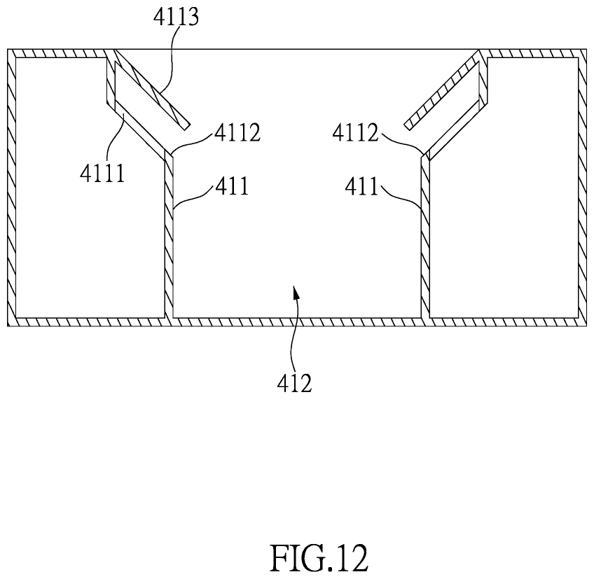

FIGS. 11 and 12 disclose another embodiment of the suction box 41, wherein the two dust boxes 411 of the suction box 41 each are provided with a plurality of baffles 4113 located at intervals on the upper side of the inclined surface 4112. The plurality of baffles 4113 are located above the dust suction holes 4111 and extend inclinedly downward and toward the air path 412 to block small parts and debris “A” from falling into the dust box 411 through the dust suction hole 4111.

The suction airflow of the air duct 20 passes through the air path 412 of the movable suction box 41, which can suck and collect dust, small parts and debris “A” directly under the processing gun 31 so as to avoid from lifting the entire processing table 10 to clean the base board. The advantages of the present invention are that:

The controller 432 can control the motor 422 to move the suction box 41 beyond the processing table 10 via the driving wheel 421, so as to clean the small parts and debris “A” in the air path 412 without of lifting the processing table 10.

With the suction box 41 moves, the suction box 41 sucks through the limited opening space of the air path 412 to form a concentrated suction effect, and achieves the required suction effect with a smaller horsepower, so as to save electric energy and can achieve the purpose of carbon reduction.

By different sizes of the suction box 41 and the air path 412, the present invention can meet the requirements of the horsepower and energy consumption factors of the motor 422.

While we have shown and described the embodiment in accordance with the present invention, it should be clear to those skilled in the art that further embodiments may be made without departing from the scope of the present invention.

What is claimed is:

1. A dust collection device comprising:
a processing table (10) including two side walls (11), and a plurality of transverse plates (12) connected between the two side walls (11), the two side walls (11) being installed on an installation floor (50);
an air duct (20) provided in the processing table (10) and located close to one of the side walls (11), a blower (60) connected to one end of the air duct (20);
a processing machine (30) including a processing gun (31) extending downward from one side of the processing machine (30), and two foot bases (32) crossing outside of the processing table (10), the processing machine (30) movable along a length direction of the processing table (10) with the two foot bases (32), and
a collection unit (40) located in the processing table (10) and including a suction box (41), a drive unit (42), and a control unit (43), the suction box (41) communicating with the air duct (20) and having two dust boxes (411) and an air path (412), the air path (412) located between the two dust boxes (411), and each dust box (411) including a plurality of suction holes (4111) that are in communication with the air path (412), the driving unit (42) including a motor (422), and a plurality of driving wheels (421) arranged on a bottom of the suction box (41), the control unit (43) including a controller (432), a transmitter (433), and a plurality of receivers (434) that are electrically connected to each other, the controller (432) electrically connected to the motor (422), the transmitter (433) transmitting wireless signals (431) which are received by the receivers (434) when the processing machine (30) moves, the controller (432) controlling the motor (422) to drive the driving unit (42) to drive the suction box (41) to move with the processing machine (30), so that suction airflow of the air duct (20) passes through the dust boxes (411) of the suction box (41) and the air path (412) to collect small parts and debris (A) below the processing gun (31), the control unit (43) controlling the motor (422) to drive the driving wheel (421) to support the suction box (41) to move out from the processing table (10) to clean the small parts and the debris (A).

2. The dust collection device as claimed in claim 1, wherein the two dust boxes (411) each have two inclined surfaces (4112) extending downwardly toward one side of the air path (412), the suction holes (4111) are located on the two inclined surfaces (4112).

3. The dust collection device as claimed in claim 1, wherein the air duct (20) has a plurality of holes (21) spaced apart on a top surface thereof, the collection unit (40) includes a turning box (44) that is connected with the air duct (20) and one end of the suction box (41), the turning box (44) includes a belt (441), a plurality of rollers (442), and a side suction port (443) and a lower suction port (444) respectively communicating with an interior of the turning box (44), two ends of the belt (441) pass through two sides of the lower suction port (444) and are connected to two ends of the top surface of the air duct (20) so as to close the holes (21) that are not located corresponding to the lower suction ports (444), the turning box (44) moves along the belt (441) on the top surface of the air duct (20) by the rollers (442), and changes positions of the holes (21) that are located corresponding to the lower suction port (444), the side suction port (443) communicates with one end of the dust box (411) and the air path (412).

4. The dust collection device as claimed in claim 1, wherein the controller (432) of the control unit (43) is located above the turning box (44), there are four receivers (424) arranged in two groups, the transmitters (422) are located to the processing machine (30) and above the receivers (434), when the wireless signal (431) between one of the two groups of the receivers (424) and the transmitters (422) is shielded by the transverse plates (12) of the processing table (10), the controller (432) receives the wireless signal (431) from another one of the two groups of the receivers (424), when the two groups of the receivers (424) are not shielded, the controller (432) takes a middle value of the wireless signals (431) received by the two groups of the receivers (424) to keep the wireless signal uninterrupted.

5. The dust collection device as claimed in claim 1, wherein the processing table (10) includes a plurality of first plates (13) and a plurality of second plates (14), the plurality of first plates (13) are arranged vertically connected to the a bottom of the transverse plates (12), the second plates (14) are arranged at intervals and connected to an upper side of the first plates (13), the transverse plates (12), the first plates (13) and the second plates (14) are adapted to support a workpiece (70).

6. The dust collection device as claimed in claim 1, wherein the driving unit (42) includes a plurality of rails (423) and a plurality of passive wheels (424), the rails (423) are provided on the installation floor (50) and are parallel to a moving direction of the processing machine (30), the passive wheels (424) are provided on a bottom of the suction box (41) and movable on the rails (423) with the driving wheels (421).

7. The dust collection device as claimed in claim 6, wherein one end of each rail (423) protrudes beyond the processing table (10), the controller (432) controls the motor (422) to drive the suction box (41) to move beyond the processing table (10) through the driving wheel (421).

8. The dust collection device as claimed in claim 2, wherein the suction box (41) includes an opening (413) provided at a bottom of the air path (412), a cover (414) removably covers the opening (413), so that when the cover (414) is removed from the opening (413), the debris (A) drops from the opening (413) and is collected.

9. The dust collection device as claimed in claim 8 further comprising a container (51) provided on the installation floor (50), a collection bucket (52) located in the container (51) so as to collect the debris (A), the collection bucket (52) having a plurality of handles (521) connected thereto.

10. The dust collection device as claimed in claim 2, wherein the two dust boxes (411) of the suction box (41) each are provided with a plurality of baffles (4113) located at intervals on the upper side of the inclined surface (4112), the plurality of baffles (4113) are located above the dust suction holes (4111) and extend inclinedly downward and toward the air path (412).
